(19) United States
(12) Patent Application Publication
(10) Pub. No.: US 2011/0039022 A1
(43) Pub. Date: Feb. 17, 2011

(54) Quick-cure leather and vinyl repair composition

(76) Inventors: Scott Adam Speer, Akron, OH (US); Melissa Leanne Speer, Akron, OH (US)

Correspondence Address: JACOBSON HOLMAN PLLC, 400 SEVENTH STREET N.W., SUITE 600, WASHINGTON, DC, 20004, US

(21) Appl. No.: 12/585,752

(22) Filed: Sep. 24, 2009

Related U.S. Application Data
(60) Provisional application No. 61/274,003, filed on Aug. 13, 2009.

(51) Int. Cl. B05D 1/00; C08K 5/10

(52) U.S. Cl. 427/140; 523/455

(57) ABSTRACT

A quick-cure repair composition which can be used to repair leather, vinyl, plastic surfaces, canvas surfaces, rubber surfaces, and fabric surfaces. The composition comprises (a) an epoxy resin; (b) an additive mixture; and (c) an activator. The additive mixture contains (i) dioctyl phthalate; (ii) a PVC resin; and (iii) optionally a silica wax. The repair composition minimizes the need for the use of solvents, and can effect repairs quickly and without the application of heat.

This application claims priority from U.S. Provisional Application Ser. No. 61/274,003, file Aug. 13, 2009, the disclosure of which is hereby incorporated by reference.

### BACKGROUND OF THE INVENTION

Vinyl and leather are commonly used for furniture, for seats in many different types of vehicles, in clothing, and in many other areas. In many applications, the vinyl or leather is subject to considerable wear and tear in the normal course of usage, and will often be damaged, either through normal wear and tear, or though accidents and/or deliberate vandalism. Regardless of the source of the damage, there has long existed a need for a means to repair such damage. While numerous patents have issued in this area, prior art compositions and methods have suffered from various deficiencies, including complicated processes for effecting the repairs, long curing times, and the need to apply heat to fully effect the repair. A further potential problem is that government regulations may limit the use of the solvents used in many prior art compositions as being potentially toxic or irritating. There remains a need for a leather and vinyl repair composition and method which addresses these concerns.

### OBJECTS OF THE INVENTION

It is therefore an object of the invention to provide a composition and method for effecting repairs in leather, vinyl, plastic surfaces, canvas surfaces, rubber surfaces, and fabric surfaces.

It is a further object of the invention to provide a leather and vinyl repair process which is completely cured in a short period of time, less than 1 hour and typically within 30 minutes.

It is a further object of the invention to provide a repair composition in which air dry shrinkage is minimized or eliminated, and in which the possibility of overheating or under heating is eliminated.

It is a further object of the invention to provide a repair composition which dries to a predetermined color, is waterproof, smooth, and even and is not tacky.

It is a further object of this invention to provide a repair composition which minimizes or eliminates the amount of solvents used, so that composition does not emit unpleasant and/or toxic gasses when the repairs are effected.

### SUMMARY OF THE INVENTION

These objects are achieved by a composition comprising an epoxy based resin, an additive mixture, and an activator, as described more fully below. In particular, the additive mixture comprises dioctyl phthalate (DOP), a polyvinylchloride (PVC) resin, and silica wax (also known as fused silica). The composition of the invention may optionally contain a thickener and/or a pigment so that the repaired surface can match the undamaged portions of the surface being repaired.

### DETAILED DESCRIPTION OF THE INVENTION

As used in this application, the phrase “completely cured” means that essentially any cross-linking reactions in the resin have been completed, and the composition is no longer tacky.

The epoxy resin used in the present invention can be any epoxy resin which will cure upon exposure to the activator. Such epoxy resins are well known to those of skill in the art, and will typically comprise epoxy-group terminated chains, which upon exposure to the activator become cross-linked. Preferably, the epoxy resin, which may include a mixture of different epoxy resins, is present in an amount from about 30% to about 95% by weight of the repair composition, more preferably from about 50% to about 90%, most preferably about 85%. One epoxy resin useful in the invention is epoxy resin 1000.

The additive mixture comprises three components (1) dioctyl phthalate (DOP), (2) a polyvinylchloride resin, and (3) optionally a fused silica (or silica wax). The three components may be present in varying amounts, but each of the DOP and the PVC resin should be present in an amount of at least 5% by weight of the additive mixture, preferably at least 20% by weight of the additive mixture. In a preferred embodiment, the three components are present in equal amounts in the additive mixture.

Dioctyl phthalate (DOP) is used in the additive mixture. Ideally, the amount of DOP is between 5% and 40% by weight of the entire composition (not simply the additive mixture), preferably between 10% and 30%, most preferably between 10% and 20%. The additive mixture also contains a polyvinylchloride (PVC) resin, and optionally silica wax (fused silica).

The activator is a conventional, epoxy-resin activator which does not require heat to cure. Typically, such activators are amines or phenoxides. Two activators which may be used in the invention are 888 by GMZ and 3217 by Hexion.

The specific composition of the epoxy resin should be chosen such that the composition will bond to or adhere to the type of surface to be repaired (e.g. vinyl, or leather, or some other surface). The specific selection of the epoxy resin can be made by one of skill in the art depending on the intended use of the repair composition.

The compositions according to the invention also include a conventional thickening agent. The thickening agent will be present in an amount from about 1% to about 20% by weight of the entire composition, more preferably from about 3% to about 10% by weight, most preferably about 5% by weight.

The compositions of the invention may also contain other ingredients, such a preservatives, anti-microbial components, etc.

The amounts of the components must be selected such that the composition is completely cured within 60 minutes of being exposed to air, preferably within 30 minutes. Once the repair composition has fully cured, it will no longer feel tacky.

The compositions of the invention may also contain dyes and/or coloring agents to enable the repaired area to more closely match the color of the undamaged area. Such dyes/coloring agents are well known in the art, and may be present in an amount sufficient to impart the necessary color, but which does not interfere with the curing of the product.

The compositions of the product may be prepared by mixing the epoxy resin and the additive mixture together by conventional means. The activator is stored separately, and is added just prior to use as its mixture with the epoxy resin will begin the curing process. The components are typically stored in air-tight containers, such as flexible metal or plastic tubes, or sealable plastic tubs.

The invention also relates to method of repairing damaged leather or vinyl surfaces (or other material) using the compositions of the invention. When the compositions are to be used, they are removed from the air-tight container—for example by being squeezed out of a tube, or scooped out of tub. The activator is added (for example, either manually mixing it with the epoxy resin/additive mixture or by mixing with the epoxy resin/additive mixture as the two are squeezed out of a tube containing separate storage containers), and the final composition is then spread evenly over the area in need of repair, and allowed to air dry (cure).

The following example is provided as a means for illustrating the invention, but should not be understood as limiting it in any way.

A composition was prepared comprising the following components: 70% epoxy resin 20% DOP, 10% PVC resin (all percentages are percentages by weight). This mixture was then combined with an activator—888 by GMZ. The resulting mixture was cured in less than 30 minutes.

1. A repair composition comprising:
(a) an epoxy resin;
(b) a additive mixture containing:
(i) dioctyl phthalate;
(ii) a PVC resin; and
(iii) optionally a silica wax; and
(c) an activator.

2. The repair composition according to claim 1, wherein the epoxy resin is present in an amount from about 30% to about 90% by weight of the composition.

3. The repair composition according to claim 2, wherein the epoxy resin is present in an amount from about 50% to about 90% by weight of the composition.

4. The repair composition according to claim 3, wherein the epoxy resin is present in an amount of about 85% by weight of the composition.

5. The repair composition according to claim 1, wherein the additive mixture is present in an amount from about 5% to about 50% by weight of the composition.

6. The repair composition according to claim 1, wherein the PVC resin and the DOP are each present in an amount of at least 5% by weight of the additive mixture.

7. The repair composition according to claim 6, wherein each component of the additive mixture is present in an amount of at least 20% by weight of the additive mixture.

8. The repair composition according to claim 1, wherein the composition further comprises a thickening agent.

9. The repair composition according to claim 1, wherein the composition further comprises a dye or coloring agent.

10. The repair composition according to claim 1, wherein the composition cures completely within 60 minutes.

11. The repair composition according to claim 10, wherein the composition cures completely within 30 minutes.

12. A method of repairing damage to a surface, the surface being selected from the group consisting of leather, vinyl, plastic, rubber, canvas, and fabric, comprising:
(1) mixing the components of the repair composition of claims 1; and
(2) spreading the resulting composition over the damaged area of the surface, and
(3) allowing the spread composition to cure.

13. The method of claim 12, wherein components (a) and (b) are mixed together prior to being mixed with component (c).
